(19) United States
(12) Patent Application Publication
(10) Pub. No.: US 2026/0045077 A1
(43) Pub. Date: Feb. 12, 2026

(54) AUTOMATED DIP MERGING IN VERTICAL AND HORIZONTAL WELLS

(71) Applicant: SCHLUMBERGER TECHNOLOGY CORPORATION, Sugar Land, TX (US)

(72) Inventors: Yassine Alexandre PERRIER, Clamart (FR); Alexis HE, Clamart (FR); Nadege BIZE-FOREST, Clamart (FR); Daniel QUESADA, Clamart (FR)

(21) Appl. No.: 19/141,349

(22) PCT Filed: May 24, 2024
(86) PCT No.: PCT/US2024/030974

§ 371 Date: Jun. 20, 2025

(30) Foreign Application Priority Data
May 25, 2023 (EP) 23305831.2

(51) Int. Cl. G06V 10/82; G06V 10/762; G06V 10/764; G06V 10/774; G06V 20/10; G06V 20/64

(52) U.S. Cl. CPC G06V 10/82; G06V 10/762; G06V 10/764; G06V 10/774; G06V 20/176; G06V 20/64

(57) ABSTRACT

A method for computing a dip orientation of a subterranean structure from a wellbore image includes conducting a lamination analysis on a received wellbore image to identify a structure therein and to compute a plurality of dip orientations of the identified structure at a corresponding plurality of the depths. The received image is further evaluating with a classification algorithm to generate a labeled image including an image label for each of a plurality of depth zones in the received image. The plurality of computed dip orientations and the image label are evaluated for at least one of the plurality of depth zones to generate a substructure therein, wherein the substructure includes a subset of the computed dip orientations. The subset of computed dip orientations in the substructure is merged to compute at least one dip orientation for the geological layer.

### CROSS REFERENCE TO RELATED APPLICATIONS

This application claims the benefit of E.P. application Ser. No. 23/305,831.2, entitled “AUTOMATED DIP MERGING IN VERTICAL AND HORIZONTAL WELLS” filed May 25, 2023, the disclosure of which is hereby incorporated herein by reference.

### BACKGROUND

A well drilled through a geological formation may pass through numerous strata of different types of rock. The interfaces between different strata of the formation may be referred to as bed boundaries. The bed boundaries form part of the structure of the geological formation. Knowing the placement of the bed boundaries in the geological formation may thus help locate zones of interest, such as those that contain oil, gas, and/or water.

In wellbore images, such as logging while drilling images, geological planar surfaces (bed boundaries, fractures, faults, etc.) may appear in the image as sinusoids (particularly in a near vertical wellbore) owing to the apparent dip angle between the planar surface and the wellbore. Determining the apparent dip from wellbore images can be useful for a number of reasons, such as for drilling into the stratum of the formation where the zone of interest is located, as well as for locating the placement of the bed boundaries throughout the geological formation.

U.S. Pat. No. 10,121,261 discloses a method for identifying and quantifying the apparent dip of formation structures from wellbore images in which an apparent dip is computed for a depth interval. The methods disclosed in the '261 patent are intended for use with formation structures that generate a sinusoid in the wellbore image. Such sinusoids are most often present in vertical or near vertical wellbores. Moreover, the disclosed methods generate a large number of partial dip orientations for a single geological surface (i.e.,for a single sinusoid in the image). There is a need for improved methods that may be utilized with inclined and horizontal wellbores.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including a logging while drilling tool.

FIG. 2 depicts an example wellbore image.

FIG. 3 depicts a flow chart of an example method for determining a dip orientation for a subterranean structure.

FIG. 4 depicts a lamination analysis portion of the method shown on FIG. 3.

FIGS. 5A-5D (collectively FIG. 5) depict example window regions extracted from an LWD image in which FIG. 5A depicts a background, FIG. 5B depicts a sinusoid bottom, FIG. 5C depicts a sinusoid top, and FIG. 5D depicts a parallel structure.

FIG. 6 depicts an example sliding window classifier 210 being translated along an image.

FIG. 7 depicts an example neural network classifier that may be used to apply the classification in the example method depicted in FIG. 3.

FIGS. 8A, 8B, and 8C (collectively FIG. 8) depict an example substructure generation for a sinusoidal zone in which FIG. 8A depicts an example image and the corresponding segments, 8B depicts the image after DBSCAN clustering, and FIG. 8C depicts the image with merged segments.

FIGS. 9A, 9B, and 9C (collectively FIG. 9) depict an example substructure generation and merging for a parallel substructure in which FIG. 9A depicts merging for a long parallel/oval-shaped structure, FIG. 9B depicts the computation of a reduced number of segments, and FIG. 9C depicts the image with a re-computed trace.

### DETAILED DESCRIPTION

Embodiments of this disclosure include methods and systems for computing a dip orientation of a subterranean structure from a wellbore image. In one example embodiment, a disclosed method includes conducting a lamination analysis on a received wellbore image to identify a structure therein and to compute a plurality of dip orientations of the identified structure at a corresponding plurality of the depths. The received image is further evaluating with a classification algorithm to generate a labeled image including an image label for each of a plurality of depth zones in the received image. The plurality of computed dip orientations and the image label are evaluated for at least one of the plurality of depth zones to generate a substructure therein, wherein the substructure includes a subset of the computed dip orientations. The subset of computed dip orientations in the substructure is merged to compute at least one dip orientation for the geological layer.

It will be appreciated that example embodiments may advantageously be utilized in a wellbore having substantially any suitable orientation, for example, including vertical, inclined, or horizontal. The disclosed example embodiments may further advantageously be applied to formation structures that generate sinusoidal, parallel, and oval structures in the wellbore image. Moreover, the disclosed embodiments may advantageously enable a unique dip orientation (or a small number of dip orientations) to be estimated for a subterranean structure (or surface) that intercepts a wellbore.

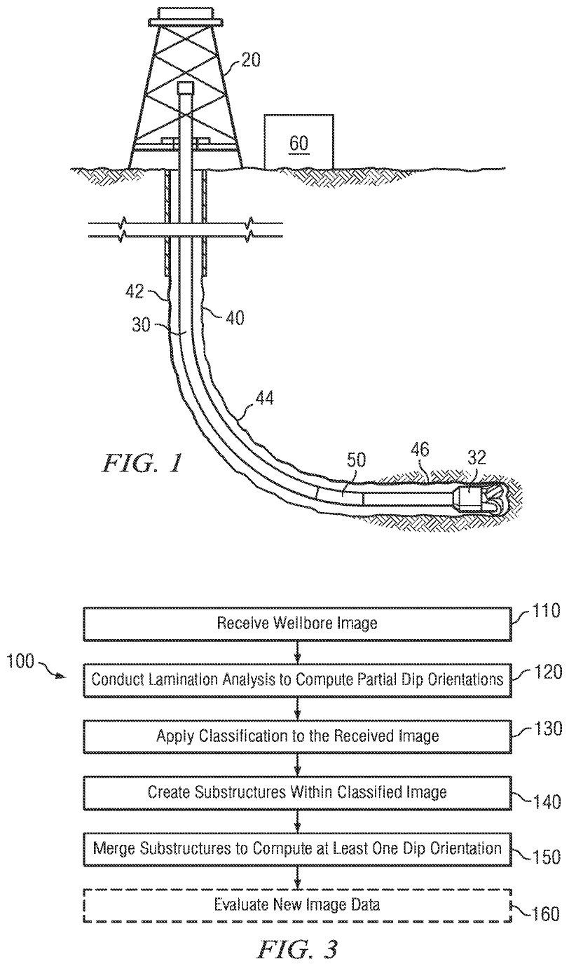

FIG. 1 depicts an example drilling rig 20 including a logging while drilling (LWD) imaging tool 50. The drilling rig 20 may be positioned over a subterranean formation (not shown). The rig may include, for example, a derrick and a hoisting apparatus (also not shown) for raising and lowering a drill string 30 and drill bit 32, which, as shown, extend into wellbore 40. The drilling rig 20 may be deployed in either onshore or offshore applications (an onshore application is depicted). Moreover, the disclosed embodiments are not limited to LWD imaging operations, but may also be employed with wireline (WL) imaging operations.

In this type of system, the wellbore 40 may be formed in subsurface formations, for example, by rotary drilling in a manner that is well-known to those or ordinary skill in the art (e.g., via well-known directional drilling techniques). The drill string 30 may be rotated, for example, at the surface or via a downhole mud motor to drill the well. A pump may deliver drilling fluid to the interior of the drill string 30 thereby causing the drilling fluid to flow downwardly through the drill string 30. The drilling fluid exits the drill string 30 via ports in the drill bit 32, and then circulates upwardly through the annular region between the outside of the drill string 30 and the wall of the wellbore 40. In this known manner, the drilling fluid lubricates the drill bit 32 and carries formation cuttings up to the surface.

The wellbore 40 may include a plurality of sections, for example, including a vertical or near vertical section 42, an inclined section 44, and a horizontal or near horizontal section. By vertical or near vertical it is meant that the wellbore section 42 has an inclination of less than 15 degrees. By inclined it is meant that the wellbore section 44 has an inclination in a range from 15 to 60 degrees. By horizontal or near horizontal it is meant that the wellbore section 46 has an inclination of greater than 60 degrees. Deviated drilling techniques used to drill such wellbore sections are well known. Moreover, it will be understood that an inclined section may be a transitional section in which the inclination is building (increasing) from near horizontal to near vertical.

The LWD imaging tool 50 may be configured to measure one or more properties of the formation through which the wellbore penetrates, for example, including resistivity, dielectric constant, density, porosity, sonic velocity, gamma ray emissions, photoelectric effect, and the like. The drill string may further include a measurement while drilling (MWD) tool (not shown) configured to measure one or more properties of the wellbore 40 as the wellbore as it is drilled or at any time thereafter. These properties may include pressure, temperature, wellbore caliper, wellbore trajectory (attitude), and the like.

With further reference to FIG. 1, drilling rig 20 may further include an onsite operations facility 60 (e.g., a control room). In the depicted embodiment, the operations facility may include an LWD image processing system, for example, including a computer or computer system. The computer system may include one or more processors (e.g., microprocessors) which may be connected to one or more data storage devices (e.g., hard drives or solid state memory) and user interfaces. It will be further understood that the disclosed embodiments may include processor executable instructions stored in the data storage device. The executable instructions may be configured, for example, to execute method 100 which is described in more detail below with respect to FIG. 3. As such, the computer system may be configured to receive a wellbore image (such as an LWD image), identify relevant formation structures in the image, and evaluate the image to compute at least one dip orientation corresponding to the formation structure. It will of course be understood that the disclosed embodiments are not limited to the use of any particular computer hardware and/or software.

It will be appreciated that WL and LWD imaging techniques are well known in oil and gas well drilling applications. For example, an LWD tool may obtain formation evaluation measurements and toolface measurements at some predetermined time interval (e.g., a 10 msec time interval) while rotating in the wellbore during a drilling operation. An LWD image may then be constructed from these formation evaluation measurements using known imaging algorithms that commonly include distributing the formation evaluation measurements into a plurality of azimuthal (toolface) sectors (also referred to as bins). WL and LWD image techniques may include, for example, gamma, neutron, resistivity, microresistivity, sonic, ultrasonic, and caliper imaging techniques.

For the purposes of this disclosure, a wellbore image may be thought of as a two-dimensional representation of a measured formation (or wellbore) parameter (e.g., logging measurements) at discrete azimuths (toolface angles) and wellbore depths. Such images thus tend to convey the dependence of the measured formation (or wellbore) parameter on the azimuth and depth. It will therefore be appreciated that one purpose in forming such is to determine the azimuthal dependence of the measured parameter(s) as a function of wellbore depth.

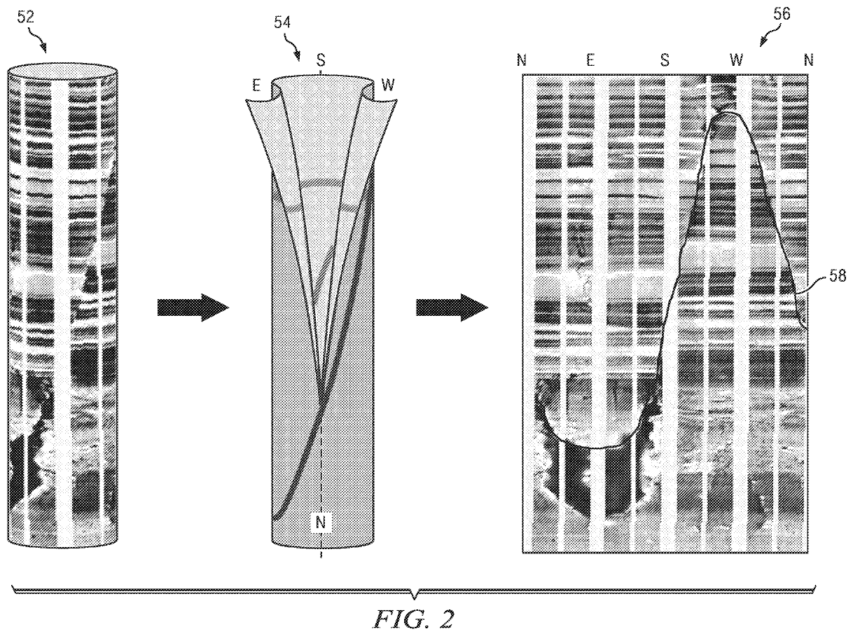

FIG. 2 depicts an example wellbore image. As described above, a logging tool, such as LWD tool 50, may acquire formation evaluation measurements in the cylindrically shaped wellbore as the tool rotates therein. The resulting cylindrical image data 52 may be unwrapped as depicted at 54 to obtain a flat image 56 in which the azimuth (toolface) angle is shown on the horizontal axis and the measured depth of the wellbore is shown on the vertical axis. A planar feature (such as a fault or a bed boundary) intercepting the wellbore may appear as a single period sinusoid 58 on the flat image 56 (particularly in a near vertical well). Evaluating the characteristics of the sinusoid (e.g., the measured depth, dip, and phase) may enable the dip orientation (the dip inclination and azimuth) of the planar feature to be determined. As described in more detail below, the disclosed embodiments are directed to methods for automatically extracting the sinusoids 58 and other features in the images, and then determining the dip orientation of the observed planar features.

Turning now to FIG. 3, a flow chart of one example method 100 for determining a dip orientation for a subterranean structure is depicted. The method may include receiving or measuring a wellbore image at 110. A lamination analysis is conducted at 120 to compute a plurality of partial dip orientations (also referred to herein as segments) at a corresponding plurality of measured depths (or over a plurality of measured depth intervals) in the received image. A classification is applied to the received image at 130, for example, using a trained neural network, to obtained an image including labeled depth zones. The classified image may be further evaluated at 140 to create substructures. The generated substructures may be merged at 150 to compute a dip orientation (dip angle and dip azimuth) for the substructure. For example, in some embodiments a single dip orientation may advantageously be computed for a sinusoidal or other substructure (indicative of a single dip angle and azimuth of a formation layer with respect to the wellbore). When working in real time (e.g., as the image data is being collected and generated line by line or depth by depth by an LWD tool during a drilling operation), the method may further include evaluating new image data (e.g., at predetermine depth or time intervals) at 160 to determine whether it is continuous with the most recent substructure, for example, via repeating at least the classification at 130.

With continued reference to FIG. 3, the wellbore image received at 110 may include substantially any suitable MWD or LWD image, for example, as described above. Moreover, the image may be received in real time while drilling. For example, the image may be received line by line (depth by depth) while the azimuthal logging data is generated during an LWD operation. As described above, the received image may be acquired from a cylindrical wellbore such that the horizontal axis of the image is indicative of the wellbore azimuth and the vertical axis is indicative of the measured depth of the wellbore. As also described above, a planar surface intersecting the wellbore may be observed as a single period sinusoid on the image.

The lamination analysis may include computing the plurality of dip orientations (also referred to herein as segments or vectors indicating that dip orientation includes a magnitude and direction in which the magnitude is the dip angle and the direction is the dip azimuth), for example, as disclosed in commonly assigned U.S. Pat. No. 10,121,261. For example, the dip orientation may be computed by moving sliding window along a depth axis of the wellbore image. A user may define a wanted refinement/precision by selecting a window height (depth interval), for example, based on known sizes of features in the wellbore image. A small window depth interval may enable more detailed vertical features to be evaluated, but may also result in a large number of dip orientations that can complicate subsequent analysis.

The lamination analysis may include dequantizing the wellbore image data. It will be understood that image data that is received at the surface is generally digitized. In example embodiments, dequantizing may include applying a Gaussian blur to the wellbore image data. The applied Gaussian blur may be a predetermined blur or may be optimized depending on the features of the image. After dequantizing, local image orientations may be computed that include information regarding the sinusoids present in the wellbore image.

For example, in one embodiment local image orientations may be determined based on a pixel-wise estimation of the local orientation of the wellbore image. An image gradient ∇I=(∂x1, ∂y1) of the wellbore image may be used that can be computed with a finite difference scheme. In some embodiments, a Hough transform may be applied to the local orientations.

Another local image orientation descriptor may include a structure tensor. The structure tensor may include a field representing a local average direction (mod π) of the gradient vectors (mod 2π). The structure tensor field S may be computed from the image gradients field ∇I by smoothing the singular matrix field ∇I⊗∇I: S=G_{μ}*∇I⊗∇I, where G_{μ} is a Gaussian kernel, and ⊗ is the outer product to a pair of vectors. The result is a matrix. In the case of real vectors, the outer product of a pair of vectors (i,j) is i⊗j=ij^{T}. The local orientation may be computed from the 2×2 matrix S(i, j), as its eigenvector associated to its largest eigenvalue, and the strength of this orientation is the largest eigenvalue. In one embodiment, the local image orientations may be determined based on the matrix S(i, j) representing the structure tensor field S. The eigenvector of the matrix with largest eigenvalue may be associated to the local orientation of the matrix S(i, j), and the strength of this orientation may correspond to the largest eigenvalue. The largest eigenvector of the matrix S(i, j) may be considered as the local orientation (u, v).

The dip orientation of the wellbore may also be computed using a Hough transform based on data relative to local orientations (orientation computed on each pixel). For example, a Hough transform may be applied to the dequantized image based on the local orientations (u, v) determined via the eigenvectors, and on the associated eigenvalue. As such, the orientation of a main bundle of sinusoids (e.g., the dip inclination and azimuth angle) appearing on a window portion (t) of a wellbore image may be determined. After applying a Hough transform, a pair of numbers (a, b) may be output that identify a bundle of planes of the form Z=ax+bY+c where Z represents the direction of the axis of the wellbore, and X points towards the north. Thus, the pair (a, b) defines a bundle of parallel dips that occur prominently in the image. By running this algorithm on a sliding window at depth t, a smooth curve of dips (a(τ), b(τ)) may be obtained that represents the evolution of the strata along the wellbore.

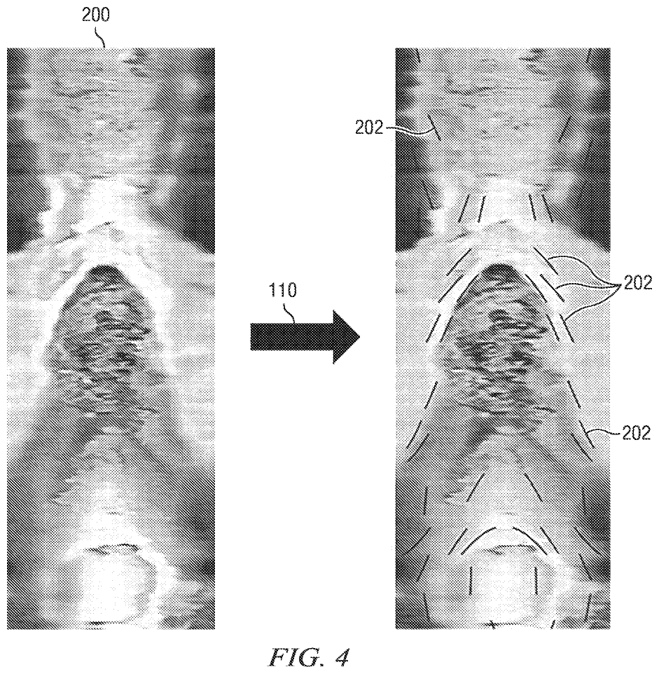

FIG. 4 schematically depicts the lamination analysis. It will be appreciated that the output of the lamination analysis in 120 is an image subdivided into a plurality of depth intervals (or a number of groups of rows in the image), in which selected depth intervals including a computed dip orientation (also referred to herein as a segment or vector including a dip angle or magnitude and a dip azimuth or direction). In FIG. 4, the received image is depicted at 200 and the segments (dip orientations) computing using the lamination analysis are depicted at 202.

With continued reference to FIG. 3, method 100 further includes applying a classification to the received image at 130. The classification may advantageously include a sliding window classifier configured to label and identify the image features and their depth limits. For example, a sliding window having a predetermined depth range (e.g., 0.5, 1, or 2 meters) may be applied to the image. In one example embodiment, the sliding window classifier evaluates multiple overlapping intervals in the image. For example, the window may have a depth range of 1.5 meters and a sliding interval of 0.5 meters such that each line in the image is classified multiple times.

The classifier may include substantially any suitable neural network (NN) or deep learning algorithm and may be configured, for example, to label the evaluated window with one of four classifications. For example, the evaluated window may be labeled as being (i) background or having no structure or minimal discernable features, (ii) a sinusoid bottom featuring the lower part or apex of a sinusoid, (iii) a sinusoid top featuring the upper part or apex of a sinusoid, or (iv) or a parallel or oval structure including substantially parallel and vertical structures that do not correspond to a full sinusoid or to the upper or lower apex of a sinusoid.

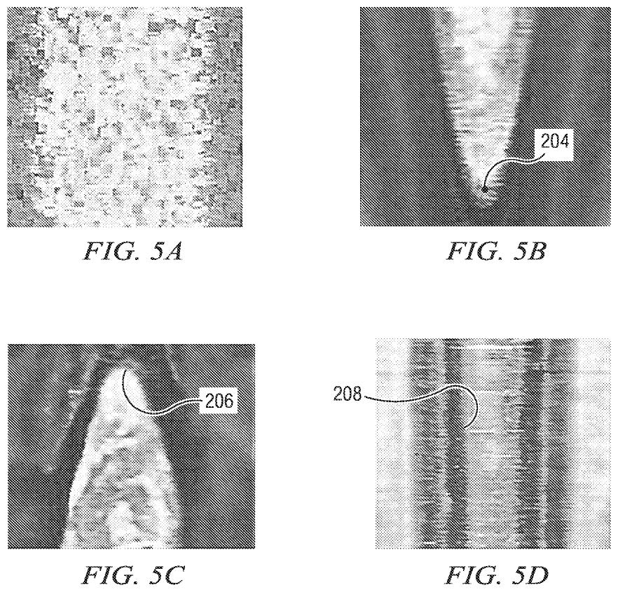

FIGS. 5A-5D depict example window regions extracted from an LWD image in which FIG. 5A depicts a background or nonlaminated structure, FIG. 5B depicts a sinusoid bottom including the lower apex of a sinusoid at 204, FIG. 5C depicts a sinusoid top including the upper apex of a sinusoid at 206, and FIG. 5D depicts parallel structure including parallel boundaries at 208. Note that in FIG. 4D, the “parallel” boundaries are not necessarily parallel, however, the region clearly includes essentially vertical boundaries that are not a sinusoidal top or bottom.

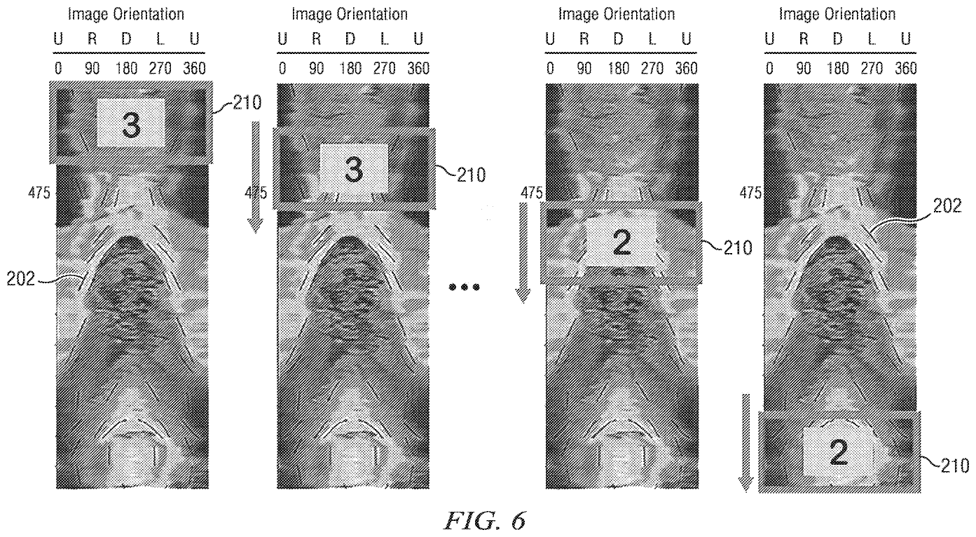

FIG. 6 depicts an example sliding window classifier 210 being translated (stepped) along a depth axis of an image. In this example, the window translation distance (or interval) is less than the window depth interval such that the classification results may overlap. This overlapping classification may lead to multiple different classifications for any particular image line (row or depth). To resolve this potential issue, the overlapping results for each line in the image may be stacked and further evaluated to obtain a final classification. For example, in one embodiment, at each line in the classification labels are counted and the label appearing the most frequently (the mode) is taken as the true label. This process may advantageously reduce uncertainty and enable the boundaries between the labeled regions to be determined more precisely. The labeled lines may then be merged into labeled zones. For example, when two or more adjacent lines have the same label (e.g., sinusoid top) they be grouped or merged into a labeled zone.

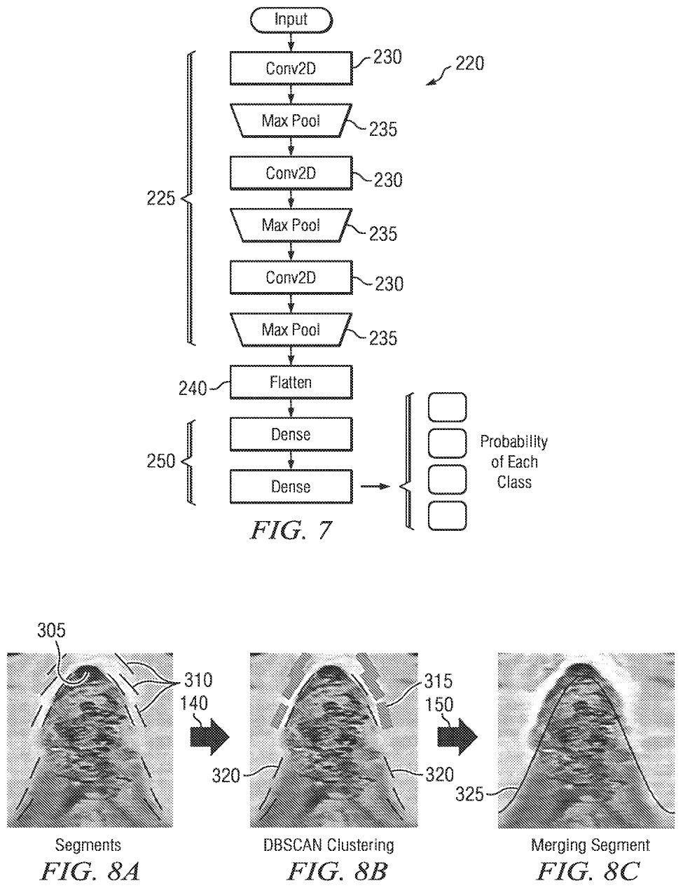

FIG. 7 depicts an example NN classifier 220 that may be used to apply the classification at 130. A first part 225 of the classifier 220 in the depicted example includes a plurality of (e.g., three) successive convolutional layers 230 interposed by max pooling layers 235. The output is received by a Flatten layer 240 and at least one (e.g., two) dense layers 250 that are configured to classify (or label) portions of the received image into one of at least three (e.g., four as described above) distinct categories (classifications). The categories may include at least a sinusoidal structure, a parallel structure, and non-laminate or no discernable structure (e.g., minimal structure or background as described above). In one example embodiment, the NN classifier 220 was coded using a Tensorflow library in python (of course the disclosed embodiments are not limited in this regard). The NN may be trained using a large number of labeled input images (e.g., up to and exceeding 1000 input images). Table 1 lists example parameters that may be used in the model training.

TABLE 1

| Input | Batch | | | | |
|---|---|---|---|---|---|
| Shape | Size | Epoch | Loss | Optimizer | Metrics |
| 600, 360 | 12 | 20 | Categorical | Adam | Accuracy |
| | | | Cross | | Precision |
| | | | Entropy | | Recall |
| | | | | | Binary Accuracy |

The output from the classification at 130 may include an image having depth zones with different labels in which each zone gathers a group of continuous pixels having the same label (e.g., sinusoid top or sinusoid bottom). The classification at 130 may further include determining the depth boundaries (e.g., identifying both the upper and lower depths) for each sub-group of pixels. For example, the difference between maximum and minimum depths in the image may be divided by the number of pixel rows in the image. The depth boundaries may then be determined from the upper and lower rows of pixels in each sub-group. The dip orientations (segments) obtained at 120 may then be loaded into each of the depth zones.

With reference again to FIG. 3, substructures may be created at 140. In one example embodiment distinct methods may be employed to create sinusoidal substructures and parallel substructures based on dip orientations determine in 120 and the classification label determined in 130. For sinusoidal zones (e.g., zones classified as sinusoid top or sinusoid bottom at 130), the segments (dip orientations) may be clustered into groups or clusters having similar dip angles and/or dip azimuths. It will be appreciated that all of the segments in a zone do not necessarily correspond to a single sinusoid within the zone. The clustering may therefore enable the segments to be grouped and associated with particular structures within the zone (e.g., with multiple sinusoidal structures in the zone). Moreover, the clustering may enable outlying segments to be identified and removed. In certain advantageous embodiments, the clustering may be conducted, for example via enforcing a density-based spatial clustering of application with noise (DBSCAN) clustering. Such a DBSCAN clustering has been found to advantageously regroup the segments by the particular sinusoid within the zone and to identify outliers given the criteria imposed on the clustering. The outliers may be deleted following the clustering.

For parallel or oval structures, the individual segments (dip orientations) may be grouped into paths (or segment traces). For example, beginning at the at the top of the zone (the lowest depth in the zone) identified segments may be connected to (or associated with) subsequent segments (at deeper depths) based on the proximity of one segment to the next to generate a path. In one example embodiment, two segments may be connected if they are located within a threshold number of pixels of one another. This process may be repeated from the top to the bottom of the zone. It will be appreciated that on occasion one segment may be within the threshold number of pixels of multiple other segments. In such instances, the closest segment may be considered to be the next segment. Alternatively, the segment that may be connected with the most other segments, thereby making up the longest path, may be considered to the be the next segment. In other embodiments, the segment having the closest dip orientation may be considered to be the next segment.

Turning again to FIG. 3, method 100 may further include merging the segments at 150 to obtain at least one dip orientation for the structure. In one example, distinct merging methods may be employed based on the classification label determined in 130 and the substructure creation in 140. For sinusoidal zones (e.g., zones classified as sinusoid top or sinusoid bottom), the segments in each cluster may be averaged (e.g., by computing a mean or median value) to compute a single dip orientation for the sinusoid. For example, each of the segments in each of the DBSCAN clusters may be averaged at 150 to obtain a single dip orientation for each cluster.

For parallel or oval structures, the individual segments within a single path may be averaged (e.g., by computing a mean or median value) to obtain one or more dip orientations for the structure (or path). For example, when a path is substantially linear, the segments in the path may be advantageously averaged to obtain a single dip orientation. When a path is non-linear (e.g., oval shaped), it may be subdivided into a plurality of (e.g., three) sub-paths along the depth of the image. In such cases, the segments in each of the sub-paths may be averaged to compute a corresponding single dip orientation for each of the sub-paths (and may advantageously be restricted to a total of three dip orientations for the whole path). It will be appreciated that in directional drilling operations, the wellbore may sometimes turn with respect a formation layer (or layers) and that dividing a path into sub-paths as described above may provide a more accurate determination of the dip orientation of the structure with depth.

FIGS. 8A, 8B, and 8C depict an example substructure generation and merging in 140 and 150 of FIG. 3 for a sinusoidal zone (sinusoidal top in this example). In FIG. 8A, an example image includes a sinusoidal top 305 and the segments 310 (dip orientations) obtained in 120. The image includes multiple segments 310 for the single sinusoidal structure as described above with respect to FIG. 3 element 120. FIG. 8B depicts the image after DBSCAN clustering at 140. Outlying dip orientations have been eliminated as indicated at 315. In this particular example, the remaining segments 320 were grouped into a single DBSCAN cluster and correspond to a single sinusoidal structure. These multiple segments represent multiple potential dip orientations for the layer represented by the sinusoid. FIG. 8C depicts the image with the merged segments (shown at 325) representing the single sinusoid. In this particular example, the merged segments include a single dip orientation describing the relative dip orientation of the layer with respect to the wellbore.

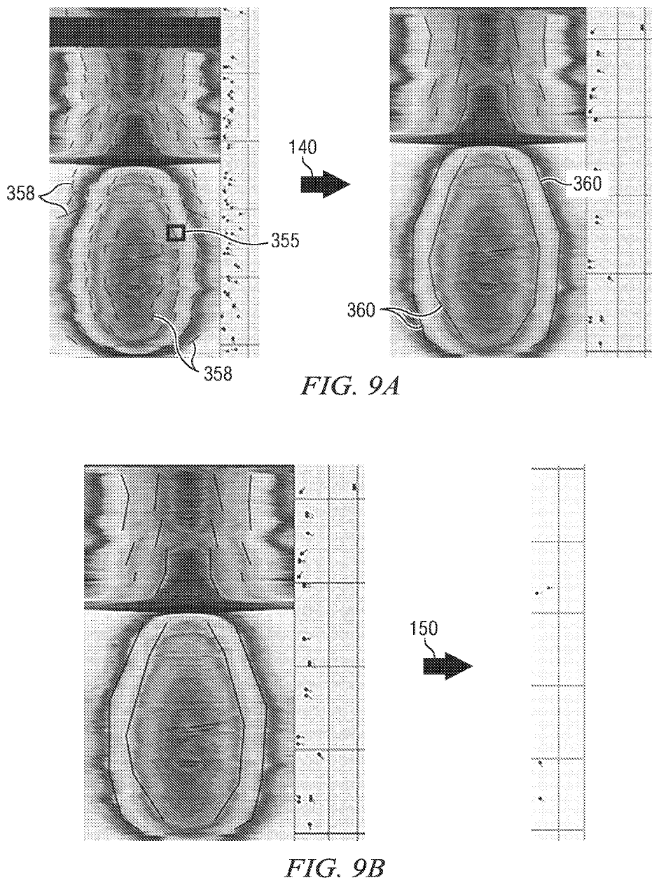

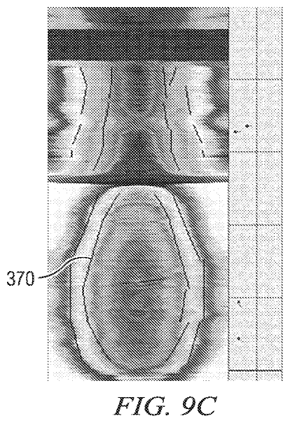

FIGS. 9A, 9B, and 9C (collectively FIG. 9) depict an example substructure generation and merging for a parallel substructure. FIG. 9A depicts a box 355 at which on segment is being connected to the next to generate a path (or paths). As described above, this process may be repeated from the top to the bottom of the zone to significantly reduce the number of segments in the image as depicted (note that there are significantly few segments 360 on the righthand side of FIG. 9A than there are segments 358 on the lefthand side of FIG. 9A.

FIG. 9B depicts the merging or averaging of the remaining segments 360 to obtain one or more dip orientations for the structure (or path). Note that the path is non-linear (e.g., oval shaped) and is therefore subdivided into a few segments. FIG. 9C depicts the recomputed trace 370 from the few remaining segments shown on FIG. 9B. The recomputed trace may advantageously provide a smooth fit of the substructure using a pixel by pixel re-computation from the top to the bottom of the substructure.

With reference again to FIG. 3, it will be appreciated that method 100 may be advantageously executed in real time while drilling a subterranean wellbore. When working in real time (e.g., as the image data is being collected and generated during a drilling operation), the method may further optionally include evaluating new image data at 160 to determine whether it is continuous with the most recent substructure or sinusoid. The new image data may be grouped into image blocks delineated by a depth or time interval. The new image data may be classified as described above using the NN and then evaluated to determine if it is continuous with the previous feature in the image. For example, when processing a new block n, the label is compared with the label of the previous zone or block n−1. If the labels are the same, the new image block may be grouped with the previous zone and method steps and the substructure creation and merging may be repeated at 140 and 150. Otherwise, when the labels are different, a new zone is created and appended to the image. In either case the continuity of the image may be advantageously preserved.

It will be understood that the present disclosure includes numerous embodiments. These embodiments include, but are not limited to, the following embodiments.

In a first embodiment, a method for determining a dip orientation of a geological layer intercepting a subterranean wellbore includes receiving a wellbore image, wherein the wellbore image is a two-dimensional representation of logging measurements at discrete azimuth angles and depths; conducting a lamination analysis on the received wellbore image to identify a structure therein and to compute a plurality of dip orientations of the identified structure at a corresponding plurality of the depths; evaluating the received wellbore image with a classification algorithm to generate a labeled image including an image label for each of a plurality of depth zones in the received wellbore image; evaluating the plurality of computed dip orientations and the image label for at least one of the plurality of depth zones to generate a substructure therein, wherein the substructure includes a subset of the computed dip orientations; and merging the subset of computed dip orientations in the substructure to compute at least one dip orientation for the geological layer.

A second embodiment may include the first embodiment, wherein the receiving the wellbore image comprises rotating a logging while drilling (LWD) tool in the subterranean wellbore; using the LWD tool to make the logging measurements while rotating in the subterranean wellbore; and constructing the wellbore image from the logging measurements.

A third embodiment may include any one of the first through second embodiments, wherein the received wellbore image comprises a logging while drilling image.

A fourth embodiment may include any one of the first through third embodiments, wherein conducting the lamination analysis comprises moving a sliding window along a depth axis in the received wellbore image to compute the plurality of dip orientations of the identified structure at the corresponding plurality of the depths.

A fifth embodiment may include any one of the first through fourth embodiments, wherein the evaluating the received wellbore image with the classification algorithm comprises translating a window classifier along a depth axis of the wellbore image, wherein a translation distance during the translating is less than a depth interval of the window classifier such that the wellbore image includes overlapping labels; and stacking the overlapping labels to obtain the image label at each of the depths in the image.

A sixth embodiment may include any one of the first through fifth embodiments, wherein the classification algorithm comprises a trained neural network including a plurality of successive convolutional layers interposed by corresponding max pooling layers, a Flatten layer, and at least one dense layer; and the trained neural network is configured to classify portions of the received image into one of at least three distinct categories including a sinusoidal structure, a parallel structure, and non-laminate structure.

A seventh embodiment may include any one of the first through sixth embodiments, wherein the evaluating the plurality of computed dip orientations and the image label for the at least one of the plurality of depth zones comprises enforcing a density-based spatial clustering of application with noise (DBSCAN) clustering of the computed dip orientations to obtain the subset of the computed dip orientations when the image label indicates a sinusoidal structure.

An eighth embodiment may include the seventh embodiment, wherein the merging the subset of computed dip orientations comprises computing an average of the dip orientations in each of the DBSCAN clusters to compute a single dip orientation for the geological layer.

A ninth embodiment may include any one of the first through eighth embodiments, wherein the evaluating the plurality of computed dip orientations and the image label for the at least one of the plurality of depth zones comprises connecting selected adjacent ones of the plurality of computed dip orientations into a path when the adjacent ones are located within a threshold number of pixels of one another when the image label indicates a parallel structure.

A tenth embodiment may include the ninth embodiment, wherein the merging the subset of computed dip orientations comprises computing an average of the dip orientations in the path to compute the at least one dip orientation for the geological layer.

An eleventh embodiment may include the tenth embodiment, wherein the merging further comprises subdividing the path into a plurality of sub-paths along the depth of the wellbore image and computing an average dip orientation for each of the sub-paths to compute a plurality of dip orientations for the geological layer.

A twelfth embodiment may include any one of the first through eleventh embodiments, further comprising: receiving new image data, the new image data including a representation of new logging measurements at discrete azimuth angles and at least one additional depth; and classifying new image data with the classification algorithm and evaluating whether the new image data is continuous with a most recent one of the plurality of depth zones.

A thirteenth embodiment may include the twelfth embodiment, further comprising grouping the new image data with the most recent one of the plurality of depth zones and repeating the evaluating the plurality of computed dip orientations and the image label and the merging when the new image data and the most recent one of the plurality of depth zones have the same classification; and creating a new depth zone and adding the new image data to the new depth zone when the new image data and the most recent one of the plurality of depth zones do not have the same classification.

In a fourteenth embodiment, a system for determining a dip orientation of a geological layer intercepting a wellbore includes a logging while drilling (LWD) tool configured to make LWD measurements during a subterranean drilling operation in the wellbore and to construct a wellbore image using the LWD measurements, wherein the wellbore image is a two-dimensional representation of the LWD measurements at discrete azimuth angles and depths in the wellbore; and a processor configured to conduct a lamination analysis on the wellbore image to identify a structure therein and to compute a plurality of dip orientations of the identified structure at a corresponding plurality of the depths; evaluate the wellbore image with a classification algorithm to generate a labeled image including an image label for each of a plurality of depth zones in the wellbore image; evaluate the plurality of computed dip orientations and the image label for at least one of the plurality of depth zones to generate a substructure therein, wherein the substructure includes a subset of the computed dip orientations; and merge the subset of computed dip orientations in the substructure to compute at least one dip orientation of the geological layer.

A fifteenth embodiment may include the fourteenth embodiment, wherein the classification algorithm comprises a trained neural network that is configured to classify portions of the received image into one of at least three distinct categories including a sinusoidal structure, a parallel structure, and non-laminate structure; the evaluate the plurality of computed dip orientations and the image label for the at least one of the plurality of depth zones comprises enforcing a density-based spatial clustering of application with noise (DBSCAN) clustering of the computed dip orientations to obtain the subset of the computed dip orientations when the image label indicates a sinusoidal structure; and the evaluate the plurality of computed dip orientations and the image label for the at least one of the plurality of depth zones comprises connecting selected adjacent ones of the plurality of computed dip orientations into a path when the adjacent ones are located within a threshold number of pixels of one another when the image label indicates a parallel structure.

In a sixteenth embodiment, a method for determining a dip orientation of a geological layer intercepting a horizontal wellbore while drilling includes rotating a bottom hole assembly in the wellbore to drill the horizontal wellbore, the bottom hole assembly including a drill bit and a logging while drilling (LWD) tool; making LWD measurements with the LWD tool while drilling the horizontal wellbore; constructing a wellbore image with the LWD measurements, the wellbore image including a two-dimensional representation of the LWD measurements at discrete azimuths and depths in the horizontal wellbore; conducting a lamination analysis on the constructed wellbore image to identify a structure therein and to compute a plurality of dip orientations of the identified structure at a corresponding plurality of the depths in the constructed image; evaluating the constructed wellbore image with a classification algorithm to generate a labeled image including an image label for each of a plurality of depth zones in the constructed image; evaluating the plurality of computed dip orientations and the image label for at least one of the plurality of depth zones to generate a substructure therein, wherein the substructure includes a subset of the computed dip orientations; and merging the subset of computed dip orientations in the substructure to compute at least one dip orientation for the geological layer.

A seventeenth embodiment may include the sixteenth embodiment, wherein the classification algorithm comprises a trained neural network configured to classify portions of the received image into one of at least three distinct categories including a sinusoidal structure, a parallel structure, and non-laminate structure; and the evaluating the received image with the classification algorithm comprises translating a window classifier along a depth axis of the wellbore image, wherein a translation distance during the translating is less than a depth interval of the window classifier such that the wellbore image includes overlapping labels and stacking the overlapping labels images to obtain the image label at each depth in the image.

An eighteenth embodiment may include any one of the sixteenth through seventeenth embodiments, wherein the evaluating the plurality of computed dip orientations and the image label for the at least one of the plurality of depth zones comprises enforcing a density-based spatial clustering of application with noise (DBSCAN) clustering of the computed dip orientations to obtain the subset of the computed dip orientations when the image label indicates a sinusoidal structure.

A nineteenth embodiment may include any one of the sixteenth through eighteenth embodiments, wherein the evaluating the plurality of computed dip orientations and the image label for the at least one of the plurality of depth zones comprises connecting selected adjacent ones of the plurality of computed dip orientations into a path when the adjacent ones are located within a threshold number of pixels of one another when the image label indicates a parallel structure.

A twentieth embodiment may include any one of the sixteenth through nineteenth embodiments, further comprising acquiring new image data while drilling, the new image data including a representation of new LWD measurements at discrete azimuth angles and at least one additional depth in the horizontal wellbore; classifying new image data with the classification algorithm and evaluating whether the new image data is continuous with a most recent one of the plurality of depth zones; grouping new image data with the most recent one of the plurality of depth zones and repeating the evaluating the plurality of computed dip orientations and the image label and the merging when the new image data and the most recent one of the plurality of depth zones have the same classification; and creating a new depth zone and adding the new image data to the new depth zone when the new image data and the most recent one of the plurality of depth zones do not have the same classification.

Although automated dip merging in vertical and horizontal wells has been described in detail, it should be understood that various changes, substitutions and alternations can be made herein without departing from the spirit and scope of the disclosure as defined by the appended claims.

What is claimed is:

1. A method for determining a dip orientation of a geological layer intercepting a subterranean wellbore, the method comprising:
receiving a wellbore image, wherein the wellbore image is a two-dimensional representation of logging measurements at discrete azimuth angles and depths;
conducting a lamination analysis on the received wellbore image to identify a structure therein and to compute a plurality of dip orientations of the identified structure at a corresponding plurality of the depths;
evaluating the received wellbore image with a classification algorithm to generate a labeled image including an image label for each of a plurality of depth zones in the received wellbore image;
evaluating the plurality of computed dip orientations and the image label for at least one of the plurality of depth zones to generate a substructure therein, wherein the substructure includes a subset of the computed dip orientations; and
merging the subset of computed dip orientations in the substructure to compute at least one dip orientation for the geological layer.

2. The method of claim 1, wherein the receiving the wellbore image comprises:
rotating a logging while drilling (LWD) tool in the subterranean wellbore;
using the LWD tool to make the logging measurements while rotating in the subterranean wellbore; and
constructing the wellbore image from the logging measurements.

3. The method of claim 1, wherein the received wellbore image comprises a logging while drilling image.

4. The method of claim 1, wherein conducting the lamination analysis comprises moving a sliding window along a depth axis in the received wellbore image to compute the plurality of dip orientations of the identified structure at the corresponding plurality of the depths.

5. The method of claim 1, wherein the evaluating the received wellbore image with the classification algorithm comprises:
translating a window classifier along a depth axis of the wellbore image, wherein a translation distance during the translating is less than a depth interval of the window classifier such that the wellbore image includes overlapping labels; and
stacking the overlapping labels to obtain the image label at each of the depths in the image.

6. The method of claim 1, wherein:
the classification algorithm comprises a trained neural network including a plurality of successive convolutional layers interposed by corresponding max pooling layers, a Flatten layer, and at least one dense layer; and
the trained neural network is configured to classify portions of the received image into one of at least three distinct categories including a sinusoidal structure, a parallel structure, and non-laminate structure.

7. The method of claim 1, wherein the evaluating the plurality of computed dip orientations and the image label for the at least one of the plurality of depth zones comprises enforcing a density-based spatial clustering of application with noise (DBSCAN) clustering of the computed dip orientations to obtain the subset of the computed dip orientations when the image label indicates a sinusoidal structure.

8. The method of claim 7, wherein the merging the subset of computed dip orientations comprises computing an average of the dip orientations in each of the DBSCAN clusters to compute a single dip orientation for the geological layer.

9. The method of claim 1, wherein the evaluating the plurality of computed dip orientations and the image label for the at least one of the plurality of depth zones comprises connecting selected adjacent ones of the plurality of computed dip orientations into a path when the adjacent ones are located within a threshold number of pixels of one another when the image label indicates a parallel structure.

10. The method of claim 9, wherein the merging the subset of computed dip orientations comprises computing an average of the dip orientations in the path to compute the at least one dip orientation for the geological layer.

11. The method of claim 10, wherein the merging further comprises subdividing the path into a plurality of sub-paths along the depth of the wellbore image and computing an average dip orientation for each of the sub-paths to compute a plurality of dip orientations for the geological layer.

12. The method of claim 1, further comprising:
receiving new image data, the new image data including a representation of new logging measurements at discrete azimuth angles and at least one additional depth; and
classifying new image data with the classification algorithm and evaluating whether the new image data is continuous with a most recent one of the plurality of depth zones.

13. The method of claim 12, further comprising:
grouping the new image data with the most recent one of the plurality of depth zones and repeating the evaluating the plurality of computed dip orientations and the image label and the merging when the new image data and the most recent one of the plurality of depth zones have the same classification; and
creating a new depth zone and adding the new image data to the new depth zone when the new image data and the most recent one of the plurality of depth zones do not have the same classification.

14. A system for determining a dip orientation of a geological layer intercepting a wellbore, the system comprising:
a logging while drilling (LWD) tool configured to make LWD measurements during a subterranean drilling operation in the wellbore and to construct a wellbore image using the LWD measurements, wherein the wellbore image is a two-dimensional representation of the LWD measurements at discrete azimuth angles and depths in the wellbore; and
a processor configured to:
conduct a lamination analysis on the wellbore image to identify a structure therein and to compute a plurality of dip orientations of the identified structure at a corresponding plurality of the depths;
evaluate the wellbore image with a classification algorithm to generate a labeled image including an image label for each of a plurality of depth zones in the wellbore image;
evaluate the plurality of computed dip orientations and the image label for at least one of the plurality of depth zones to generate a substructure therein, wherein the substructure includes a subset of the computed dip orientations; and
merge the subset of computed dip orientations in the substructure to compute at least one dip orientation of the geological layer.

15. The system of claim 14, wherein:
the classification algorithm comprises a trained neural network that is configured to classify portions of the received image into one of at least three distinct categories including a sinusoidal structure, a parallel structure, and non-laminate structure;
the evaluate the plurality of computed dip orientations and the image label for the at least one of the plurality of depth zones comprises enforcing a density-based spatial clustering of application with noise (DBSCAN) clustering of the computed dip orientations to obtain the subset of the computed dip orientations when the image label indicates a sinusoidal structure; and
the evaluate the plurality of computed dip orientations and the image label for the at least one of the plurality of depth zones comprises connecting selected adjacent ones of the plurality of computed dip orientations into a path when the adjacent ones are located within a threshold number of pixels of one another when the image label indicates a parallel structure.

16. A method for determining a dip orientation of a geological layer intercepting a horizontal wellbore while drilling, the method comprising:
rotating a bottom hole assembly in the wellbore to drill the horizontal wellbore, the bottom hole assembly including a drill bit and a logging while drilling (LWD) tool;
making LWD measurements with the LWD tool while drilling the horizontal wellbore;
constructing a wellbore image with the LWD measurements, the wellbore image including a two-dimensional representation of the LWD measurements at discrete azimuths and depths in the horizontal wellbore;
conducting a lamination analysis on the constructed wellbore image to identify a structure therein and to compute a plurality of dip orientations of the identified structure at a corresponding plurality of the depths in the constructed image;
evaluating the constructed wellbore image with a classification algorithm to generate a labeled image including an image label for each of a plurality of depth zones in the constructed image;
evaluating the plurality of computed dip orientations and the image label for at least one of the plurality of depth zones to generate a substructure therein, wherein the substructure includes a subset of the computed dip orientations; and
merging the subset of computed dip orientations in the substructure to compute at least one dip orientation for the geological layer.

17. The method of claim 16, wherein:
the classification algorithm comprises a trained neural network configured to classify portions of the received image into one of at least three distinct categories including a sinusoidal structure, a parallel structure, and non-laminate structure; and
the evaluating the received image with the classification algorithm comprises translating a window classifier along a depth axis of the wellbore image, wherein a translation distance during the translating is less than a depth interval of the window classifier such that the wellbore image includes overlapping labels and stacking the overlapping labels images to obtain the image label at each depth in the image.

18. The method of claim 16, wherein the evaluating the plurality of computed dip orientations and the image label for the at least one of the plurality of depth zones comprises enforcing a density-based spatial clustering of application with noise (DBSCAN) clustering of the computed dip orientations to obtain the subset of the computed dip orientations when the image label indicates a sinusoidal structure.

19. The method of claim 16, wherein the evaluating the plurality of computed dip orientations and the image label for the at least one of the plurality of depth zones comprises connecting selected adjacent ones of the plurality of computed dip orientations into a path when the adjacent ones are located within a threshold number of pixels of one another when the image label indicates a parallel structure.

20. The method of claim 16, further comprising:
acquiring new image data while drilling, the new image data including a representation of new LWD measurements at discrete azimuth angles and at least one additional depth in the horizontal wellbore;
classifying new image data with the classification algorithm and evaluating whether the new image data is continuous with a most recent one of the plurality of depth zones;
grouping new image data with the most recent one of the plurality of depth zones and repeating the evaluating the plurality of computed dip orientations and the image label and the merging when the new image data and the most recent one of the plurality of depth zones have the same classification; and
creating a new depth zone and adding the new image data to the new depth zone when the new image data and the most recent one of the plurality of depth zones do not have the same classification.
